(19) United States
(12) Patent Application Publication
(10) Pub. No.: US 2017/0077733 A1
(43) Pub. Date: Mar. 16, 2017

(54) WIRELESS POWER TRANSMITTING UNIT USING METAL PLATES

(71) Applicant: QUALCOMM Incorporated, San Diego, CA (US)

(72) Inventors: Seong Heon Jeong, San Diego, CA (US); William Henry Von Novak, III, San Diego, CA (US)

(21) Appl. No.: 14/849,952

(22) Filed: Sep. 10, 2015

(51) Int. Cl. H02J 7/02; H02J 7/04

(52) U.S. Cl. CPC H02J 7/025; H02J 7/04

(57) ABSTRACT

An apparatus for wireless power transmission may include several electrically conductive plates separated from each other by slots and arranged to define a charging surface. A current driving circuit disposed among the plurality of electrically conductive plates can be configured to produce a flow of current in one or more of the plurality of electrically conductive plates. Resulting magnetic fields can emanate from the slots to establish a charging area about the charging surface for wireless transfer of power to one or more power receiving via the magnetic fields.

### TECHNICAL FIELD

The present disclosure relates generally to wireless power transmission systems. More particularly, the present disclosure relates to wireless power transmitting units (charging pads).

### BACKGROUND

Wireless power transfer is becoming increasingly popular in portable electronic devices, such as mobile phones, computer tablets, etc., which typically require long battery life with low battery weight requirements. The ability to power an electronic device without the use of wires provides a convenient solution for users of portable electronic devices. Wireless power transfer gives manufacturers a tool for developing creative solutions to problem due to having limited power sources in consumer electronic devices. The technology's benefits can be seen in the many portable devices, from cell phones to electric cars, that normally operate on battery power.

### SUMMARY

In accordance with the present disclosure, an apparatus for wireless power transmission may include electrically conductive plates that are electrically separated from each other by a plurality of slots. A current driving circuit may be provided among the electrically conductive plates. The current driving circuit may be configured to induce, in one or more of the plurality of electrically conductive plates, eddy currents that can cause magnetic fields to emanate from the slots to establish a charging area about the charging surface for wireless transfer of power to a power receiving unit.

In some aspects, the current driving circuit may include at least one coil of conductive material. The coil of conductive material may be exposed through one or more of the electrically conductive plates. The current driving circuit may further include a capacitor to establish a resonant frequency for the current driving circuit. In some aspects, the coil of conductive material may be wound about the periphery of the charging surface.

In some aspects, the current driving circuit may include a first coil of conductive material disposed across a first set of the plurality of electrically conductive plates and a second coil of conductive material arranged inside a perimeter of the first coil of conductive material that intersects some of the slots, and electrically connected together by connector.

In some aspects, the current driving circuit may include one or more coils of conductive material disposed at a periphery of the charging surface.

In some aspects, the current driving circuit may induce eddy currents in some of the electrically conductive plates (source plates). In response, eddy currents in others of the plurality of electrically conductive plates may be induced by the source plates.

In some aspects, the current driving circuit may include a first conductor that lies along a first side of the charging surface and at least a second conductor that lies along a second side of the charging surface.

In some aspects, the apparatus may include a magnetic shielding material disposed on one or more of the electrically conductive plates.

In some aspects, the apparatus may include a signal feed connected to a first electrically conductive plate.

In accordance with the present disclosure, a wireless power transmitting unit may include a charging surface configured to produce magnetic fields for wireless transmission of power to one or more power receiving units. The charging surface may comprise electrically conductive plates, physically spaced apart from each other and electrically separable from each other. The wireless power transmitting unit may include first switches selectively and separately operable to electrically connect or disconnect pairs of electrically conductive plates. The first switches may form a first configuration of connected and disconnected electrically conductive plates to define a first power transmitting element. First and second terminals may provide power to the first power transmitting element to generate magnetic fields which emanate from a set of electrically conductive plates that comprise the first power transmitting element.

In some aspects, the first switches may be disposed in the slots between the electrically conductive plates. In some aspects, each first switch may be connected between four of the electrically conductive plates, and operable to connect together any combination of the four electrically conductive plates.

In some aspects, some of the electrically conductive plates may be electrically connected to the first terminal, for example to receive electrical power. In some aspects, the wireless power transmitting unit may include second switches connect or disconnect some of the electrically conductive plates to the second terminal, for example to serve as an electrical power return.

In some aspects, the wireless power transmitting unit may include a controller to operate the first switches to connect together different electrically conductive plates to define one or more power transmitting elements.

In some aspects, the controller may operate the first switches to reconfigure a first configuration of connected and disconnected electrically conductive plates to form a second configuration of connected and disconnected electrically conductive plates in response to information received from one or more power receiving units.

In accordance with the present disclosure, a method for wireless power transmission may include producing one or more flows of current among one or more metal plates that are arranged to define a charging surface. The method may include producing magnetic fields in response to the flow of current. The method may include coupling the magnetic fields to a power receiving unit in proximity to the charging surface to wirelessly transmit power to the power receiving unit.

In some aspects, the one or more flows of current may be produced by providing current to a coil of conductive material disposed on some of the metal plates to induce eddy currents in others of the plurality of metal plates.

In some aspects, the one or more flows of current may be produced by operating a plurality of switches configured to electrically connect or disconnect pairs of the metal plates to define a power transmitting element and providing power to the power transmitting element to generate magnetic fields that emanate from slots between the metal plates of the first power transmitting element.

In accordance with the present disclosure, a wireless power transmission may include means for producing flows of current among some of the metal plates, and means for generating magnetic fields that arise due to the flows of current among the metal plates in order to couple the magnetic fields to a power receiving unit disposed in proximity to the charging surface to wirelessly transmit power to the power receiving unit.

In some aspects, the means for producing flows of current may comprise one or more coils of conductive material disposed some of the metal plates to induce current among some of the metal plates.

In some aspects, the means for producing flows of current may comprises a switches configured to electrically connect or disconnect pairs of the metal plates.

The following detailed description and accompanying drawings provide a better understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. In the accompanying drawings:

FIG. 1 is a functional block diagram of a wireless power transfer system in accordance with an illustrative embodiment.

FIG. 2 is a functional block diagram of a wireless power transfer system in accordance with an illustrative embodiment.

FIG. 3 is a schematic diagram of a portion of transmit circuitry or receive circuitry of FIG. 2 including a power transmitting or receiving element in accordance with an illustrative embodiment.

FIG. 4 illustrates an embodiment of a charging surface in accordance with the present disclosure.

FIGS. 4A and 4B illustrate alternative embodiments of a charging surface in accordance with the present disclosure.

FIG. 5 illustrates an embodiment of a current driving circuit in accordance with the present disclosure.

FIG. 5A illustrates a charging area about a charging surface.

FIG. 6 illustrates generation of magnetic fields in accordance with the present disclosure.

FIGS. 7A and 7B illustrate an example of shaping a magnetic field in accordance with the present disclosure.

FIGS. 8A, 8B, 9, 10, 10A, and 11 illustrate alternatives to establishing a charging area in accordance with the present disclosure.

FIGS. 12A, 12B, and 12C illustrate an aspect of the present disclosure relating to radio frequency communications.

FIGS. 13A and 13B show an embodiment of a charging surface in accordance with some embodiments that uses a slotted metal plate.

FIGS. 14 and 14A illustrate a charging surface in accordance with the present disclosure.

FIGS. 15A, 15B, and 15C illustrate examples of configurations of the charging surface illustrated in FIG. 14.

FIG. 16 illustrates a charging surface in accordance with the present disclosure.

FIGS. 16A, 16B, and 16C illustrate aspects of the charging surface of FIG. 16.

FIG. 17 illustrates and example of a configuration of the charging surface of FIG. 16.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “power receiving element” to achieve power transfer.

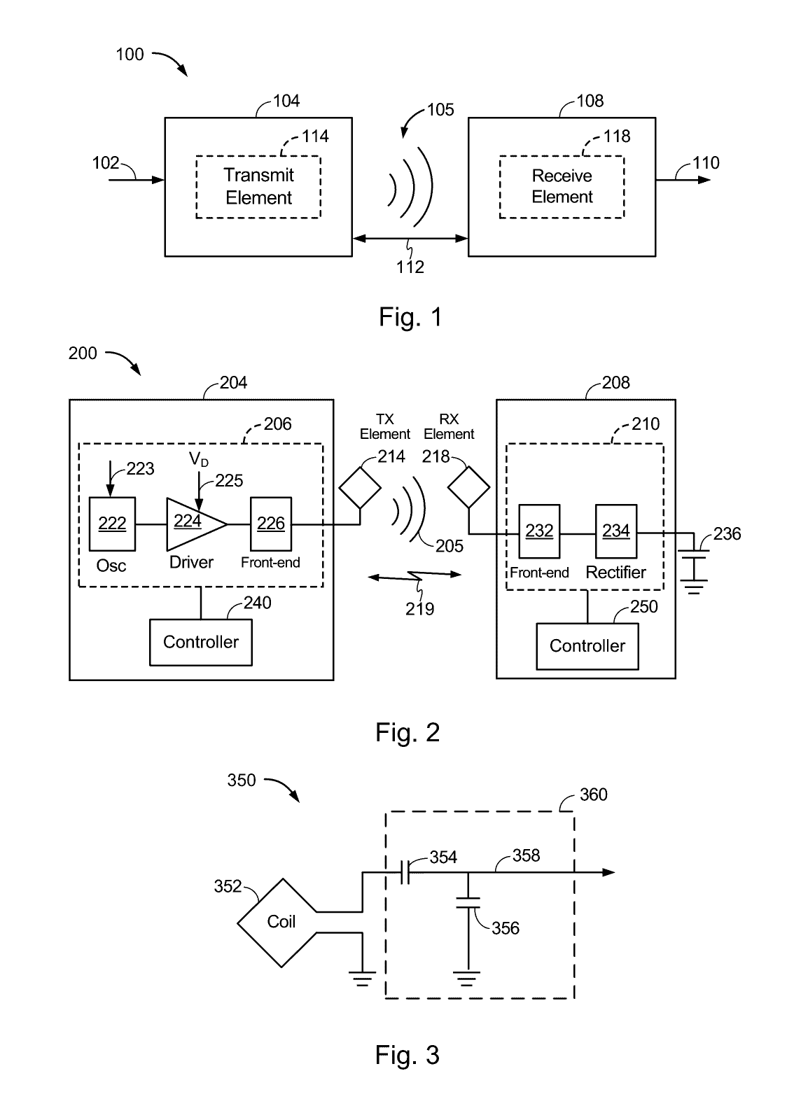

FIG. 1 is a functional block diagram of a wireless power transfer system 100, in accordance with an illustrative embodiment. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) coupled to the output power 110. The transmitter 104 and the receiver 108 may be separated by a distance 112. The transmitter 104 may include a power transmitting element 114 for transmitting/coupling energy to the receiver 108. The receiver 108 may include a power receiving element 118 for receiving or capturing/coupling energy transmitted from the transmitter 104.

In one illustrative embodiment, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for improved efficiency and power transfer over various distances and with a variety of inductive power transmitting and receiving element configurations.

In certain embodiments, the wireless field 105 may correspond to the “near field” of the transmitter 104. The near-field may correspond to a region in which there are strong reactive fields resulting from the currents and charges in the power transmitting element 114 that minimally radiate power away from the power transmitting element 114. The near-field may correspond to a region that is within about one wavelength (or a fraction thereof) of the power transmitting element 114.

In certain embodiments, efficient energy transfer may occur by coupling a large portion of the energy in the wireless field 105 to the power receiving element 118 rather than propagating most of the energy in an electromagnetic wave to the far field.

In certain implementations, the transmitter 104 may output a time varying magnetic (or electromagnetic) field with a frequency corresponding to the resonant frequency of the power transmitting element 114. When the receiver 108 is within the wireless field 105, the time varying magnetic (or electromagnetic) field may induce a current in the power receiving element 118. As described above, if the power receiving element 118 is configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge or to power a load.

FIG. 2 is a functional block diagram of a wireless power transfer system 200, in accordance with another illustrative embodiment. The system 200 may include a transmitter 204 and a receiver 208. The transmitter 204 (also referred to herein as power transfer unit, PTU) may include transmit circuitry 206 that may include an oscillator 222, a driver circuit 224, and a front-end circuit 226. The oscillator 222 may be configured to generate a signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or otherwise powering a load.

The transmitter 204 may further include a controller 240 operably coupled to the transmit circuitry 206 configured to control one or aspects of the transmit circuitry 206 or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by it. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) may include receive circuitry 210 that may include a front-end circuit 232 and a rectifier circuit 234. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. In certain embodiments, the transmitter 204 may be configured to generate a predominantly non-radiative field with a direct field coupling coefficient (k) for providing energy transfer. Receiver 208 may directly couple to the wireless field 205 and may generate an output power for storing or consumption by a battery (or load) 236 coupled to the output or receive circuitry 210.

The receiver 208 may further include a controller 250 configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to minimize transmission losses between the transmitter 204 and the receiver 208.

FIG. 3 is a schematic diagram of a portion of the transmit circuitry 206 or the receive circuitry 210 of FIG. 2, in accordance with illustrative embodiments. As illustrated in FIG. 3, transmit or receive circuitry 350 may include a power transmitting or receiving element 352 and a tuning circuit 360. The power transmitting or receiving element 352 may also be referred to or be configured as an antenna or a “loop” antenna. The term “antenna” generally refers to a component that may wirelessly output or receive energy for coupling to another “antenna.” The power transmitting or receiving element 352 may also be referred to herein or be configured as a “magnetic” antenna, or an induction coil, a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown in this figure).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil or other inductor forming the power transmitting or receiving element 352. Capacitance (e.g., a capacitor) may be provided by the tuning circuit 360 to create a resonant structure at a desired resonant frequency. As a non limiting example, the tuning circuit 360 may comprise a capacitor 354 and a capacitor 356 may be added to the transmit and/or receive circuitry 350 to create a resonant circuit.

The tuning circuit 360 may include other components to form a resonant circuit with the power transmitting or receiving element 352. As another non limiting example, the tuning circuit 360 may include a capacitor (not shown) placed in parallel between the two terminals of the circuitry 350. Still other designs are possible. In some embodiments, the tuning circuit in the front-end circuit 226 may have the same design (e.g., 360) as the tuning circuit in front-end circuit 232. In other embodiments, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352.

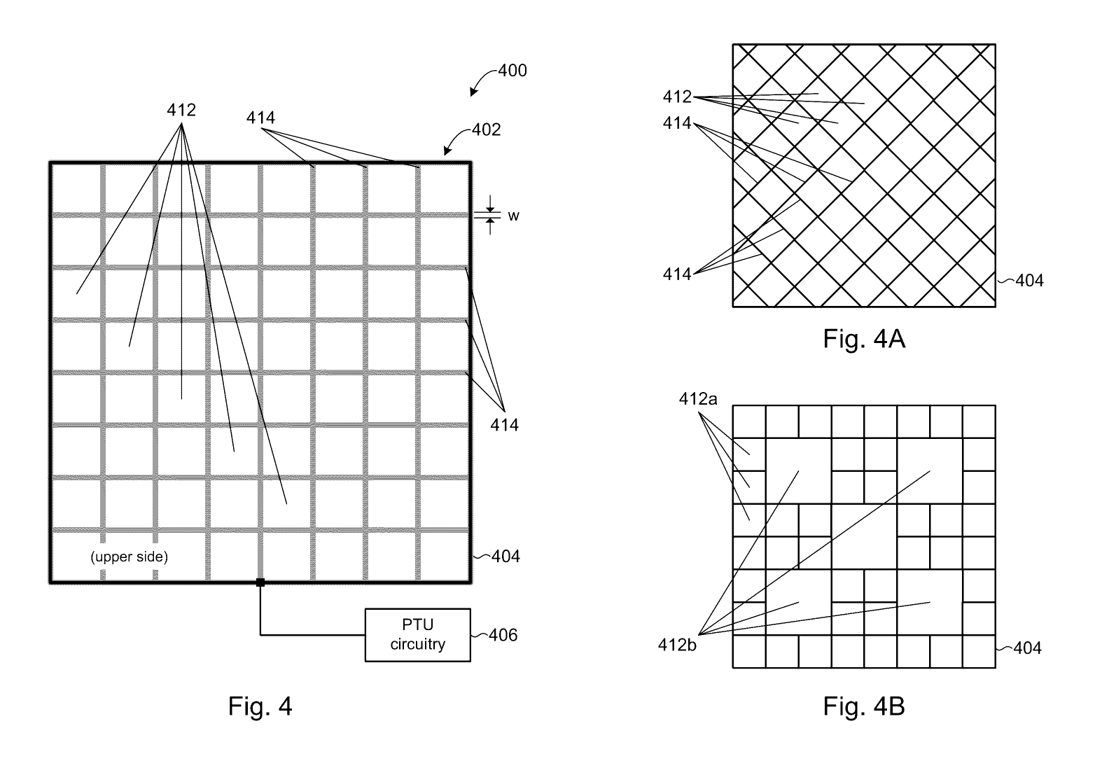

The discussion will now turn to descriptions of wireless power transfer units (PTUs), for example such as the transmitter 204 shown in FIG. 2, in accordance with the present disclosure. Referring to FIG. 4, a PTU 400 in accordance with some embodiments of the present disclosure may comprise a charging platform 402 and PTU circuitry 406. The figure depicts the upper (top) side of the charging platform 402. The PTU circuitry 406 may include circuitry for driving the charging platform 402. This aspect of PTU 400 will be discussed in more detail.

The charging platform 402 may include a charging surface 404 on which one or more devices (e.g., PRUs) can be placed to for wireless charging. In accordance with the present disclosure, the charging surface 404 may comprise an arrangement of plates 412. The plates 412 may be metal or other electrically conductive material. In some embodiments, the plates 412 may comprise several different electrically conductive materials. The upper side of the charging surface 404 may be visible, and so the selection of one or more types of electrically conductive materials for the plates 412 may be motivated for aesthetic reasons to achieve a desired visual design or pattern. In some embodiments, a coating (not shown) may be provided on the plates 412, for example, to avoid oxidation of an exposed metallic surface. Since the plates 412 may expose moderate voltages, the coating may be an electrically insulative material. The coating may be transparent to reveal the underlying surface (e.g., for aesthetic reasons), or the coating may be translucent or opaque.

The plates 412 may be electrically separated or spaced apart from each other by a series of slots 414 that physically separate the plates 412 from each other. The plates 412 may be supported on a frame or other means for arranging the plates 412 to define the charging surface 404. In some embodiments, for example, the slots 414 may be defined by affixing the plates 412 on a substrate (not shown) in an arrangement that leaves spacing between the plates 412. In other embodiments, the slots 414 may be filled with an electrically non-conductive material in order to hold the plates 412 together. In some embodiments, the slot width w can be the same for all slots 414. In other embodiments, the slot width w may vary. In some embodiments, the charging surface 404 may be planar, such as depicted in FIG. 4 for example. In other embodiments, the charging surface 404 may be a contoured, 3-dimensional surface.

FIGS. 4A and 4B illustrate alternate arrangements of the plates 412 that comprise the charging surface 404. FIG. 4A, for example, shows that the slots 414 may run in directions other than horizontally and vertically as shown in FIG. 4. In some embodiments, for example, the slots 414 may run diagonally, and more generally the slots 414 may run in different orientations. In other embodiments, the slots 414 may be curved. In still other embodiments, the slots 414 may comprise a combination of straight segments and curved segments, and so on.

FIG. 4A further illustrates that the plates 412 that comprise the charging surface 404 may be other shapes; for example, diamond shaped. In other embodiments, the plates 412 may have other geometric shapes, such as triangular, hexagonal, etc. FIG. 4B illustrates that the plates 412a, 412b may be different sizes. In general, the plates 412 may be have arbitrary shapes. For example, the shapes may be selected for aesthetic reasons since, in some embodiments, the upper surface of the charging surface 404 may be visible. In addition, the charging surface 404 may be contoured, rather than planar as shown in the figures.

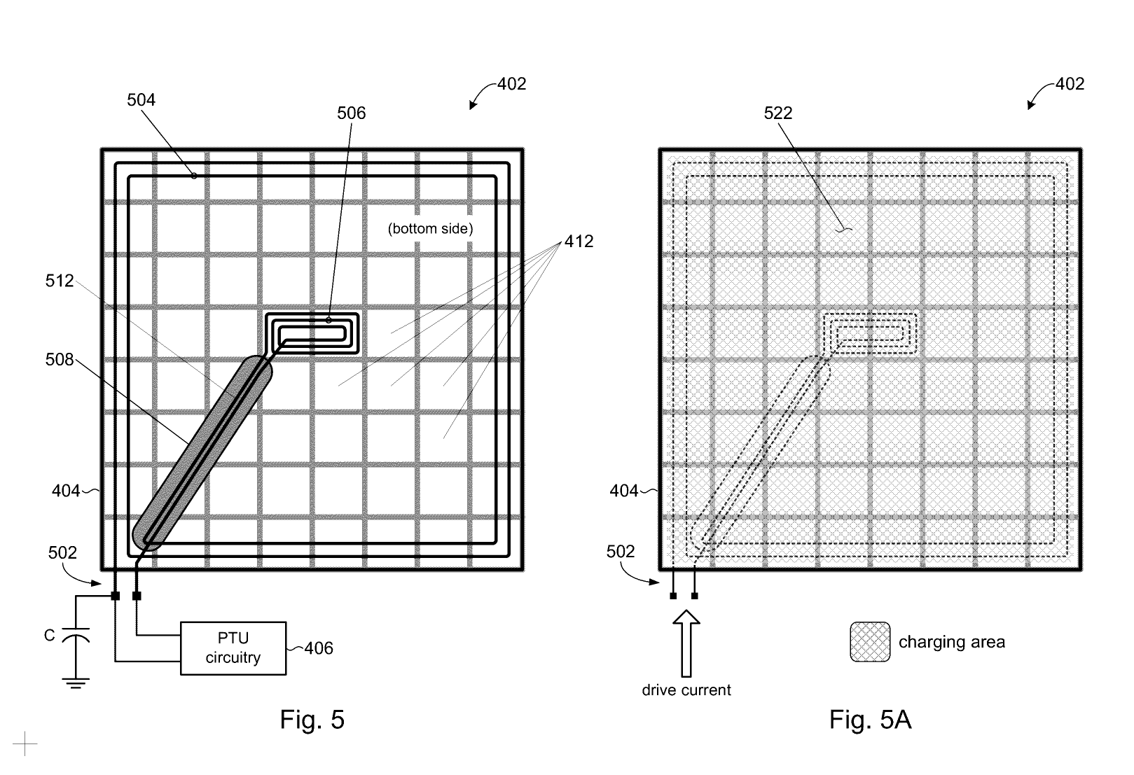

FIG. 5 illustrates an example of the charging platform 402 of PTU 400 (FIG. 4) seen from the bottom side. The charging platform 402 may further include a current driving circuit 502 disposed among the plates 412 that comprise the charging surface 404. In some embodiments, for example, the current driving circuit 502 may be affixed to the bottom side of the charging surface 404. The PTU circuitry 406 may include, or receive power from, a power source (e.g., current source, not shown) to provide a drive current to drive the current driving circuit 502. In some embodiments, the charging platform 402 may further include a capacitor C that may be electrically connected the current driving circuit 502 to define a resonator for coupling with PRUs (not shown).

In some embodiments, the current driving circuit 502 may comprise one or more coils of conductive material (“coils”) 504, 506. In some embodiments, for example, the 504, 506 may be flexible printed circuit board (PCB) wire, printed, or stamped coil. In other embodiments, however, the coils 504, 506 may be any suitable electrically conductive material. FIG. 5 shows that in some embodiments, the current driving circuit 502 may be about the same size as the charging the surface 404.

The coils 504, 506 may be wound in any suitable manner. In some embodiments, for example, the coil 504 may be wound about an outer periphery of the charging surface 404 and disposed or lain across plates 412 at the outer periphery of the charging surface 404. The coils 504, 506 may any number of turns. FIG. 5, for example, shows that coil 504 has two turns. In the example shown in FIG. 5, the coil 506 has three turns and is disposed across two inner plates 412 of the charging surface 404.

The coil 506 may be smaller than coil 504 and may be arranged inside the perimeter established by coil 504. A connector 512 may connect the two coils 504, 506, and be driven by a single power source (e.g., provided in the PTU circuitry 406). A magnetic shield 508 may be provided between the connector 512 and plates 412 beneath the connector 512 in order to avoid distorting a magnetic field for wireless charging. In some embodiments, the connector 512 may be omitted and the coils 504, 506 may be driven by separate respective power sources (not shown).

FIG. 5A shows the upper side of charging platform 402 of PTU 400 (FIG. 4). When a drive current (e.g., AC) is provided to the current driving circuit 502, magnetic fields can arise from the charging surface 404 to establish a charging area (charging region) 522 about the charging surface 404. Accordingly, when one or more PRUs (not shown) are placed on or near the charging surface 404, the magnetic fields that comprise the charging area 522 can couple to the one or more PRUs for wireless transfer of power from the charging platform 402 of the PTU 400 to the one or more PRUs that are in proximity to the charging area 522.

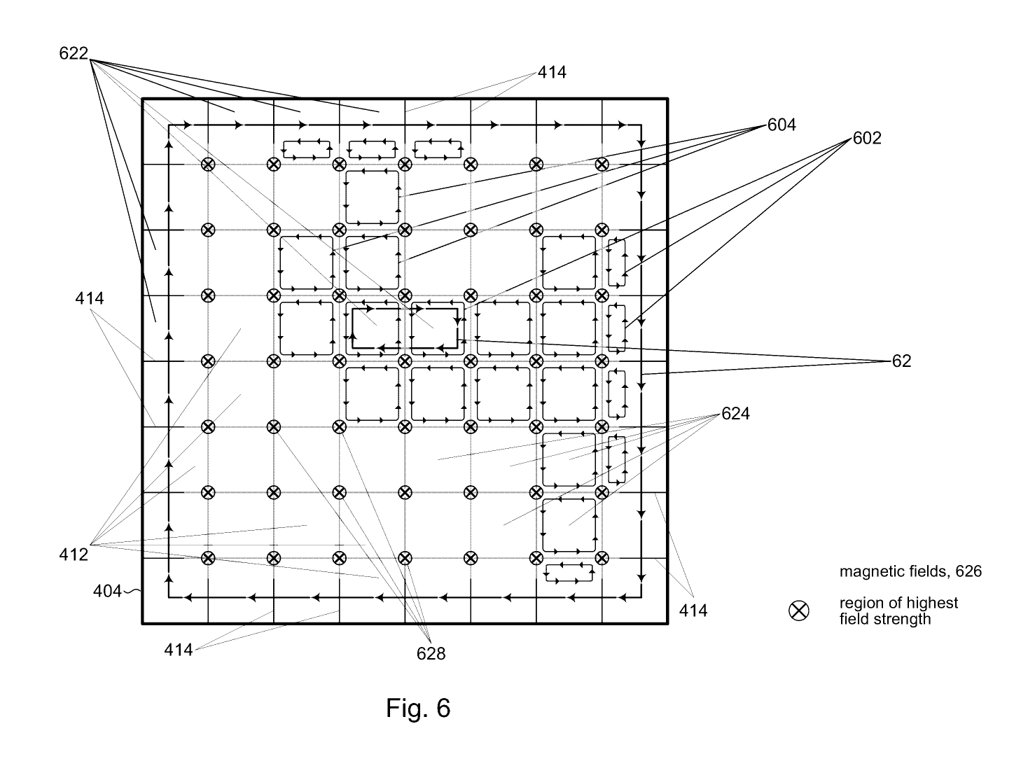

FIG. 6 shows how magnetic fields may arise on a charging surface 404 in accordance with the present disclosure. The explanation can be made with respect to the coils 504, 506 shown in FIGS. 5 and 5A, without loss of generality. The coils 504, 506 have been omitted in the FIG. 6 to avoid cluttering the figure. In addition, the figure shows examples of eddy currents for only some of the plates 412, also in order to reduce clutter in the figure. One of ordinary skill will understand that eddy current flows can be induced in the other plates 412.

In operation, some of the plates 412 may act as “source” plates 622 and some of the plates 412 may act as “non-source” plates 624. The coils 504, 506 may be driven by a drive current to create a flow of current 62 as shown in FIG. 6. Eddy currents 602 can be directly induced in plates 412 on which the coils 504, 506 lie across in response to the magnetic field generated by the coils 504, 506. Such plates may be designated the source plates 622. The directly induced eddy currents 602, in turn, can indirectly induce eddy currents 604 in plates 412 that are adjacent the source plates 622 based on the magnetic fields generated by the source plates 622 due to the eddy currents in the source plates 622. Such plates may be designated the non-source plates 624. Eddy currents induced in non-source plates 624 may in turn induce eddy currents in adjacent plates, and so on. In this way, induced eddy currents may propagate from plate 412 to plate 412 across the charging surface 404.

The slots between plates 412 may act as means for generating magnetic fields or otherwise allowing them to be present over the charging surface 404. For example, as a result of the presence of the induced eddy currents 602, 604, magnetic fields 626 can arise and emanate from the slots 414 on the charging surface 404. These magnetic fields 626 are indicated in FIG. 6 by the gray regions that overlie the slots 414. The magnetic fields 626 can extend across the surfaces of the plates 412 and combine to create a charging area (e.g., 522, FIG. 5A) on the charging surface 404. Regions of highest field strength may be found at the intersections 628 where slots 414 cross each other.

In accordance with the present disclosure, the magnetic fields 626 may be “shaped.” In other words, the distribution of the magnetic fields 626 on the charging surface 404 may be varied. Shaping may include varying the strength of the magnetic fields 626 on the charging surface. For example, the strength of the magnetic fields 626 that emanate from a slot 414 can be varied by changing the width (e.g., w, FIG. 4) of the slot 414. Accordingly, in some embodiments, the width of the slots 414 may vary across the charging surface 404. The width of the slots 414 may vary gradually, in some embodiments. In other embodiments, the width of the slots 414 may be discrete, and so on.

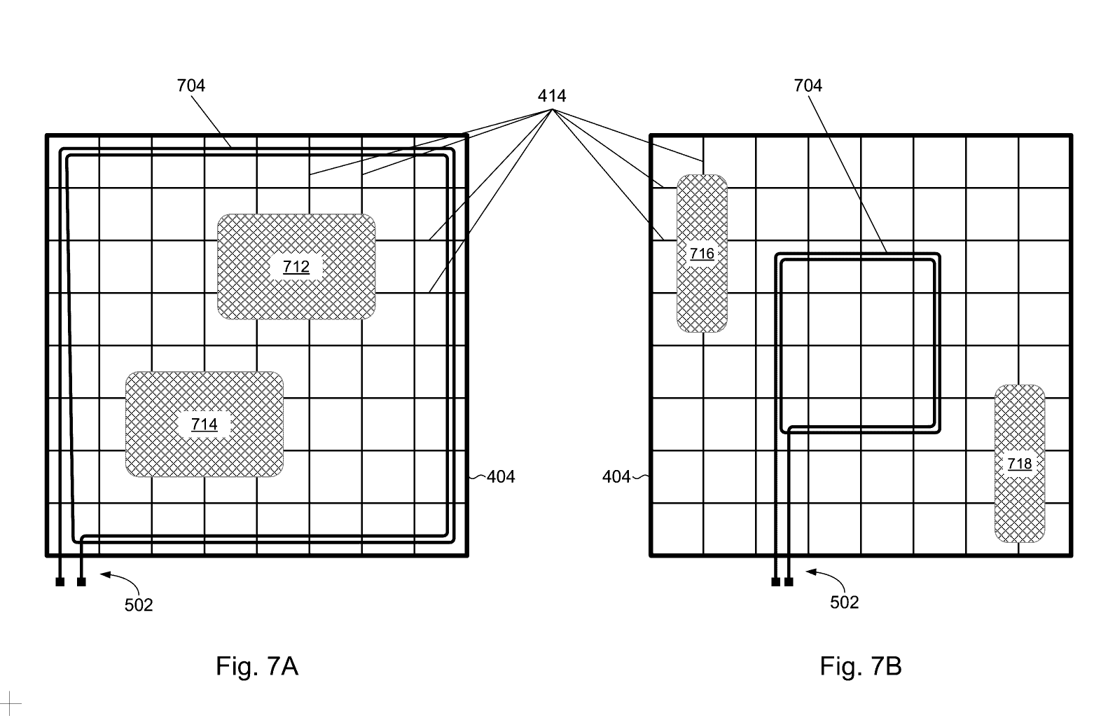

In some embodiments, the magnetic fields 626 can be shaped by the placement of magnetic shield material on the charging surface 404. FIGS. 7A and 7B illustrate this aspect of the present disclosure. In FIG. 7A, the current driving circuit 502 may establish a perimeter defined by a coil 704 that comprises the current driving circuit 502. One or more magnetic shield patches 712, 714 may be affixed to the charging surface 404, and in particular may be placed across the slots 414 on the charging surface 404. The patches 712, 714 may be any suitable ferrite material.

In some embodiments, the patches 712, 714 may be positioned within the perimeter established by the current driving circuit 502. In some embodiments, the patches 712, 714 may be positioned outside of that perimeter. FIG. 7B, for example, shows an embodiment that illustrates the placement of patches 716, 718 outside the perimeter established by the current driving circuit 502 as defined by coil 704. The patch placements shown in FIGS. 7A and 7B are merely illustrative. The actual number of patches used and their placement will vary depending on design. In some embodiments, for example, the design may call for only a single patch. In other embodiments, several patches may be employed.

In operation, a patch can prevent or otherwise impede magnetic fields (e.g., 626, FIG. 6) that emanate from the slots 414. Patches can therefore alter where the magnetic fields emanate from the charging surface. A placement of one or more patches on the charging surface 404 can therefore shape the distribution of the magnetic fields to achieve a uniform distribution of magnetic fields. In some embodiments, the patches may be used to define regions on the charging surface 404 that have high magnetic field strength separated by regions that have low magnetic field strength. In other embodiments, other distributions of magnetic fields may be accomplished. In general, magnetic fields on the charging surface 404 can be shaped by varying the slot width of the slots 414 (described above) and/or placement of patches (e.g., 712, 714) on the charging surface 404.

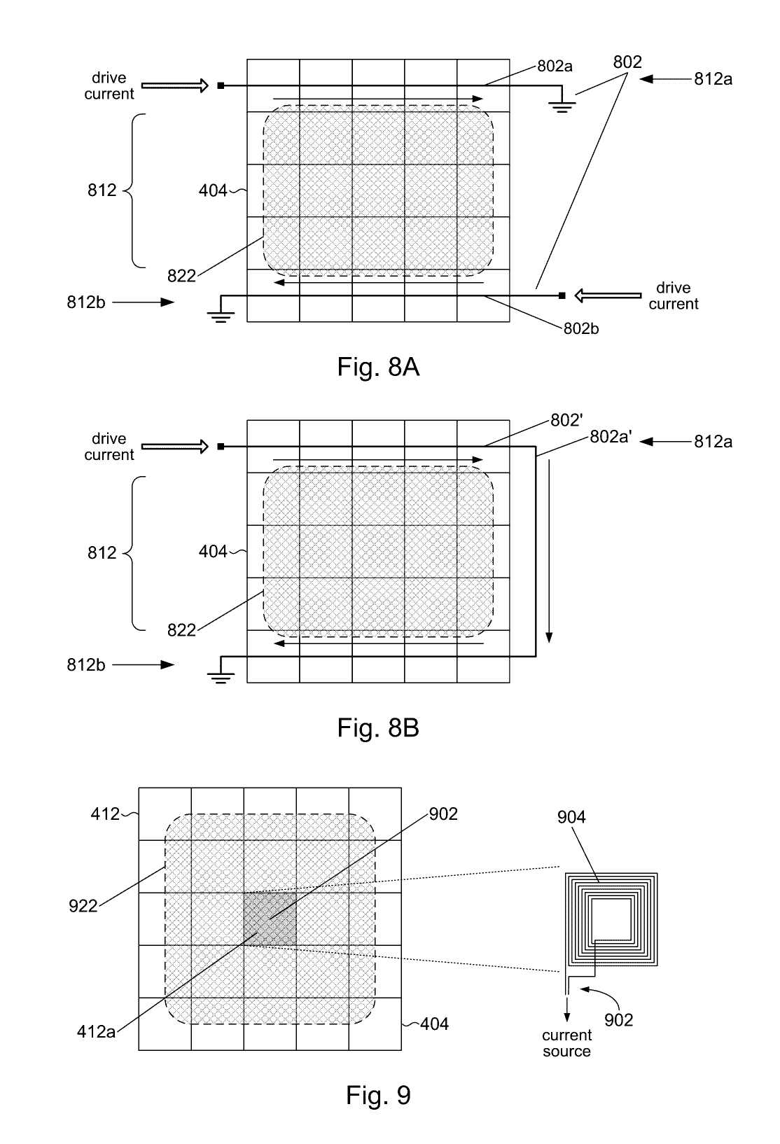

FIGS. 8A and 8B illustrate a current driving circuit 802 in accordance with some embodiments of the present disclosure. Referring to FIG. 8A, in some embodiments, the current driving circuit 802 may comprise two or more linear conductors 802a, 802b comprising electrically conductive material. The linear conductors 802a, 802b may be driven by the same drive current, or by different drive currents. The linear conductors 802a, 802b, may be disposed across a line of adjacent plates 812a, 812b that comprise the charging surface 404. For example, linear conductor 802a may run along one side at a periphery of the charging surface 404, across a row of plates 812a. Likewise, linear conductor 802b may run along an opposite side at the periphery of the charging surface 404, across another row of plates 812b. During operation, when the current driving circuit 802 is driven, the magnetic field may establish a charging area 822 between the linear conductors 802a, 802b. For example, the flow of current in the linear conductors 802a, 802b may create eddy currents in the row of plates 812a, 812b, which in turn may induce eddy currents in the center plates 812 to the magnetic field.

FIG. 8B shows an embodiment of a current driving circuit 802′ that comprises a single conductor having a return segment 802a′ that lies outside of the charging surface 404. This embodiment may be advantageous in some instances because a single source of drive current is needed, whereas the embodiment in FIG. 8A may require separate current sources to drive the linear conductors 802a, 802b.

FIG. 9 illustrates an embodiment of a current driving circuit 902 comprising a single coil 904. As shown in FIG. 9, in some embodiments, the current driving circuit 902 may be about the size of a plate 412 that comprises the charging surface 404. The number of turns in the coil 904 may be high, in order to generate sufficiently strong magnetic fields to establish a charging area 922. Merely to illustrate, the number of turns in coil 904 may be 10-20 turns for example. In some embodiments, the coil 904 may lie beneath a plate 412a. In other embodiments, the coil 904 may be “exposed” in that the charging surface 404 does not have a metal plate in the location of the coil 904. A clear epoxy or other electrically insulative coating may be disposed on the coil 904, however, to provide protection from the environment. Exposing the coil 904 in this way may be desirable from an aesthetics or design point of view.

Although not illustrated, in other embodiments, the coil 904 may be larger. In some embodiments for example, the coil 904 may be about the size of a 2×2 array of plates 412. In general, a coil that comprises a current driving circuit may be any suitable size, ranging from the size of coil 504 shown in FIG. 5 to the size of coil 904 shown in FIG. 9.

In operation, a magnetic field generated by the driving circuit 902 may induce eddy currents in plate 412a. Eddy currents in plate 412a may induce eddy currents in adjacent plates, which in turn may induce eddy currents in other adjacent plates, and so on. In this way, induced eddy currents may propagate from plate 412 to plate 412 across the charging surface 404.

In some embodiments, plate 412a may be omitted. If the coil 904 is adjacent to plates 412, then a magnetic field that arises when the coil 904 is driven may induce eddy currents in those plates. Induced eddy currents may propagate from plate 412 to plate 412 across the charging surface 404.

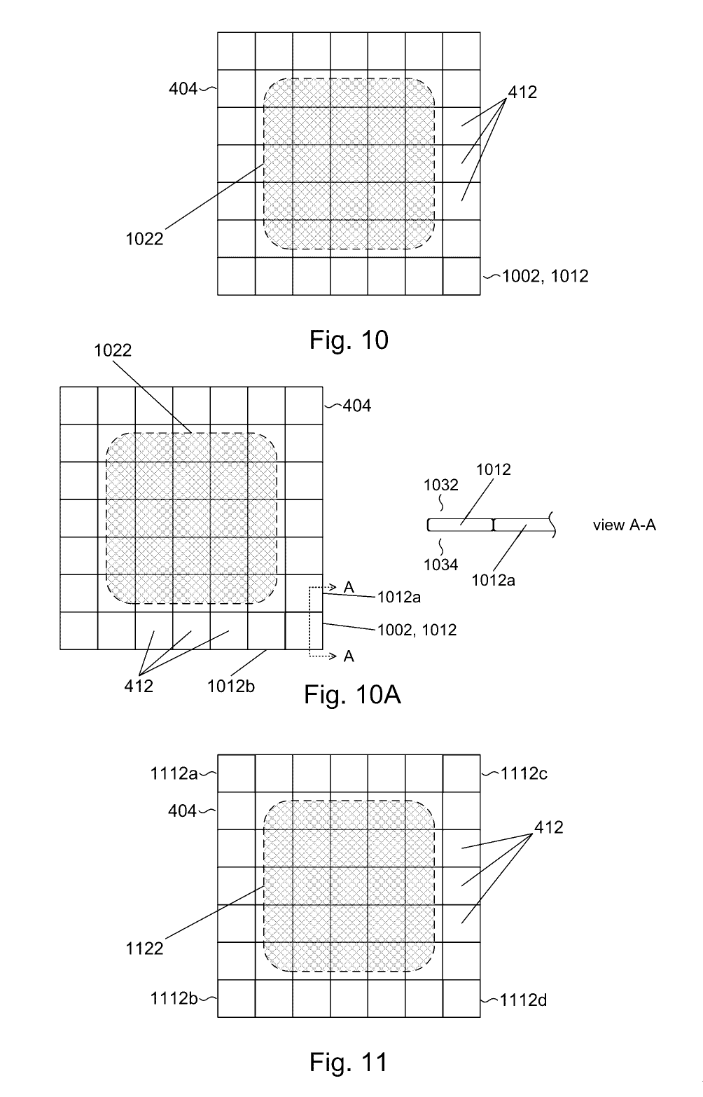

FIG. 10 shows that in some embodiments, a current driving circuit 1002 (e.g., coil 904, FIG. 9) can be placed in a corner plate 1012 of the charging surface 404. The current driving circuit 1002 can generate a charging area 1022 that extends toward the interior region of the charging surface 404. As in FIG. 9, the current driving circuit 1002 may lie beneath metal plate 1012 or may metal plate 1012 may be omitted to expose the current driving circuit 1002. FIG. 10A shows that in some embodiments, magnetic shielding 1032, 1034 may be used to suppress the formation of eddy currents in plates 1012a, 1012b that are adjacent to the corner plate 1012. In other embodiments, either magnetic shielding 1032 or 1034 can be used to expose the top or bottom side. The magnetic shielding 1032, 1034 may be provided, for example, to reduce electromagnetic interference (EMI) effects at the corner of charging surface 404 of corner plate 1012.

In operation, eddy currents may be induced in plates 1012, 1012a, 1012b due to a magnetic field that may be generated when the current driving circuit 1002 is driven. Eddy currents induced in plates 1012, 1012a, 1012b may in turn induce eddy currents in adjacent plates 412, and so on. In this way, induced eddy currents may propagate from the corner of the charging surface 404 across the charging surface 404.

FIG. 11 shows that in some embodiments, current driving circuits (e.g., coil 904, FIG. 9) may be placed at corner plates 1112a, 1112b, 1112c, 1112d to establish a charging area 1122. In other embodiments current driving circuits may be placed in two corner plates or three corner plates. The magnetic shielding sandwich configuration shown in FIG. 10A may be used to reduce EMI effects. As in FIG. 9, one or more of the corner plates 1112a, 1112b, 1112c, 1112d may be omitted to expose the current driving circuits.

In operation, eddy currents may be induced in corner plates 1112a, 1112b, 1112c, 1112d due to a magnetic field that may be generated when current driving circuits (e.g., coil 904, FIG. 9) at each plate 1112a, 1112b, 1112c, 1112d are driven. Eddy currents induced in plates 1112a, 1112b, 1112c, 1112d may in turn induce eddy currents in adjacent plates 412, and so on. In this way, induced eddy currents may propagate from the four corners of the charging surface 404 across the charging surface 404.

In some embodiments, the plates (e.g., 412, FIG. 4) may be used for radio frequency (RF) communication. RF signals may be any suitable signaling technique, for example, Bluetooth, WiFi, GPS, LTE, WCDMA, GSM, etc. In some embodiments, the PTU (e.g., 400, FIG. 4) can coordinate wireless charging with a PRU (not shown) by communicating with the PRU using RF signaling. For example, depending on a particular embodiment, the communication may be used to determine how much power to deliver to the PRU, the loading in the PRU, the PRU temperature, and so on.

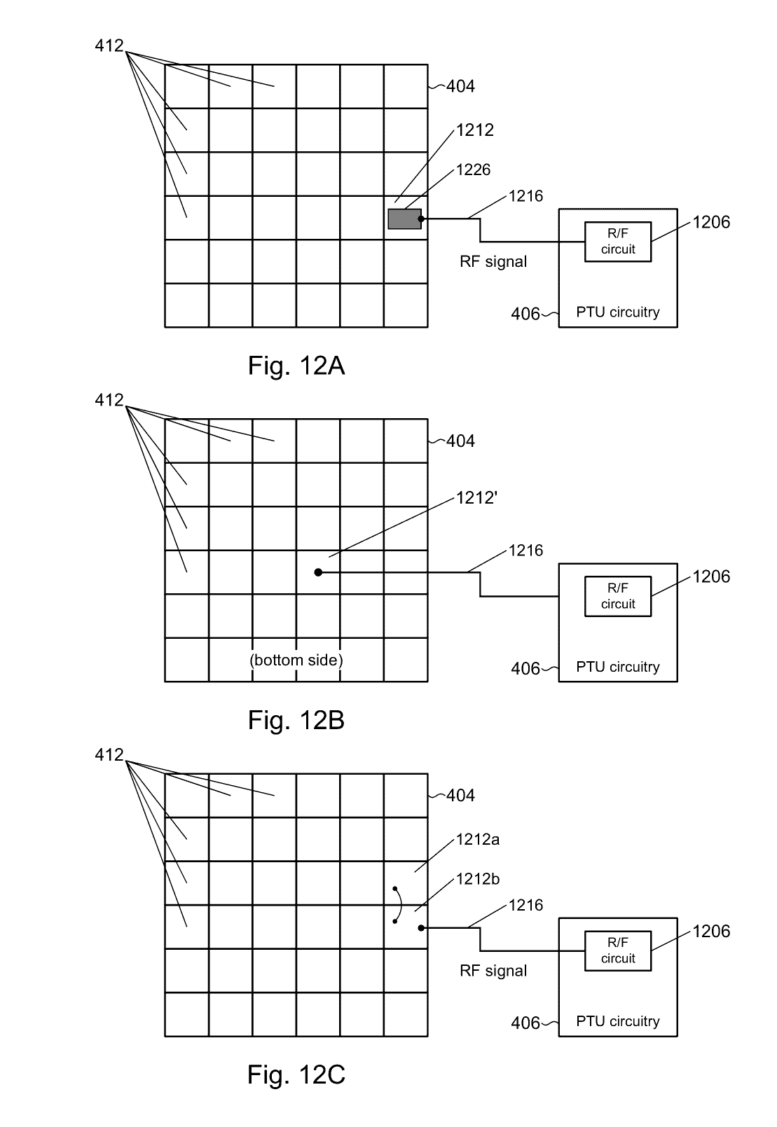

Referring to FIG. 12A, in some embodiments, the PTU circuitry 406 in a PTU may include an RF circuit 1206 to provide for communication, e.g., with a PRU (not shown). In accordance with the present disclosure, a feed 1216 from the RF circuit 1206 may connect directly to one or more of the plates 412 that comprise the charging surface 404. FIG. 12A shows, for example, that the charging surface 404 may receive the feed 1216 from the side, and in particular a plate 1212 on the outer periphery of the charging surface. In some embodiments, an antenna (e.g., patch antenna) 1226 may be provided on plate 1212 and the feed 1216 connected to the antenna 1226.

In other embodiments, as shown in FIG. 12B for example, a plate 1212′ that is located inside the periphery of the charging surface 404 may be used by the feed 1216. FIG. 12B illustrates that in some embodiments, the feed 1216 may be directly connected to the plate 1212′, for example on the bottom side of the charging surface 404, to used the plate 1212′ itself as the antenna.

In some embodiments, the plates 412 can be driven at a frequency of 6.78 MHz for wireless power transmission. RF signals can operate outside of the 6.78 MHz operating frequency for wireless power transmission. Accordingly, the PTU circuit 406 may include a duplexer (not shown) to support concurrent wireless power transmission operation and RF communication. In some embodiments, the PTU circuit 406 may include a diplexer (not shown) to switch between wireless power transmission operation and RF communication.

FIG. 12C shows that in some embodiments, two or more plates 1212a, 1212b may be electrically connected together to support RF communication. Depending on the frequency band of the RF signal, a single plate 412 may be large enough to transmit the RF signal. However, the wavelengths of lower frequency RF may require a size that is larger than a single plate 412. Accordingly, two or more plates 1212a, 1212b may be connected together to produce an antenna of sufficient size to transmit a particular frequency band.

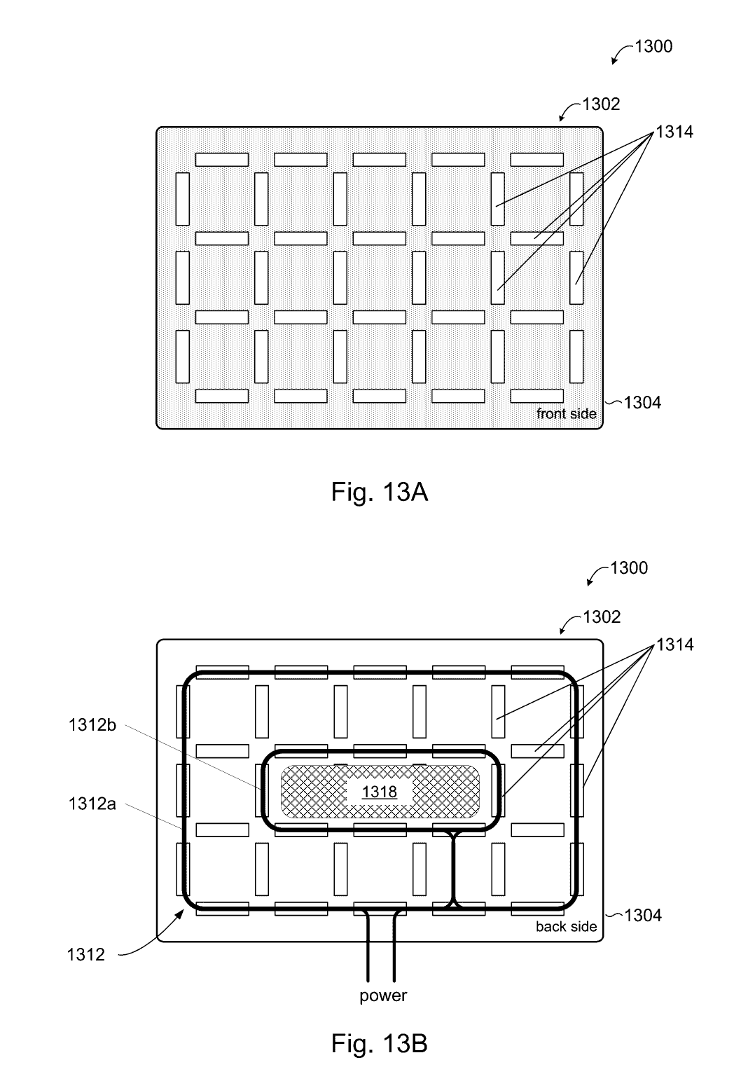

FIG. 13A shows a PTU 1300 in accordance with some embodiments of the present disclosure. The PTU 1300 may comprise a charging platform 1302. The figure depicts the front side of the charging platform 1302. The charging platform 1302 may include a charging surface 1304 on which one or more devices (e.g., PRUs) can be placed to for wireless charging. In accordance with the present disclosure, the charging surface 1304 may comprise a metal plate having slots 1314 formed through the metal plate.

FIG. 13B shows the back side of the charging surface 1304 of PTU 1300. In accordance with some embodiments, one or more coils 1312 may be wound on the back side of the charging surface. In accordance with the present disclosure, the coil 1312 may be aligned with the slots 1314. In some embodiments a ferrite material 1318 may be provided to increase mutual inductance.

In operation, when power is applied to the coil 1312, magnetic fields generated due to current flow through the coil 1312 can emanate from the slots 1314 to couple to a PRU. A tuning capacitor (not show) may be connected to the coil 1312 to tune a resonant frequency of the magnetic field.

The number of turns in the coil 1312 can determine the distribution of the magnetic field and its magnitude. FIG. 13B, for example, shows the coil 1312 comprises two sets of turns 1312a, 1312b. The outer turns 1312a are wound around the outer periphery of the slotted charging surface 1304, and aligned with slots 1314 at the outer periphery. The inner turns 1312b are wound about an inner periphery and aligned with slots 1314 at the inner periphery. The outer turns 1312a and inner turns 1312b may be connected to define a single coil having a single current path. In other embodiments, the charging surface 1304 may comprise two or more separate coils with separate current paths.

In some embodiments, the charging surface 1304 may be planar, such as depicted in FIGS. 13A and 13B for example. In other embodiments, the charging surface 1304 may be a contoured, 3-dimensional surface.

In some embodiments, the slots 1314 may be rectangular, such as shown in FIGS. 13A and 13B for example. In other embodiments, the slots 1314 may be any shape; e.g., triangular, circular, octagonal, hexagonal, irregular, etc. The slot shape may be selected for aesthetic reasons.

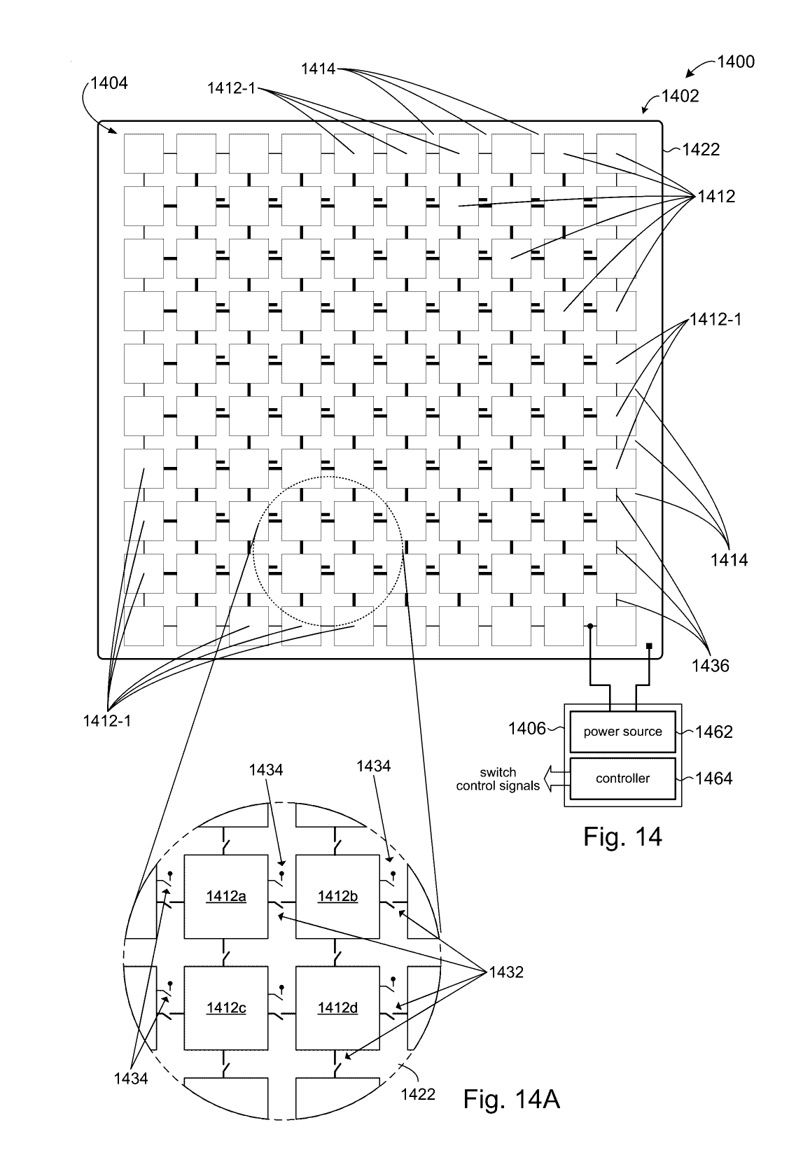

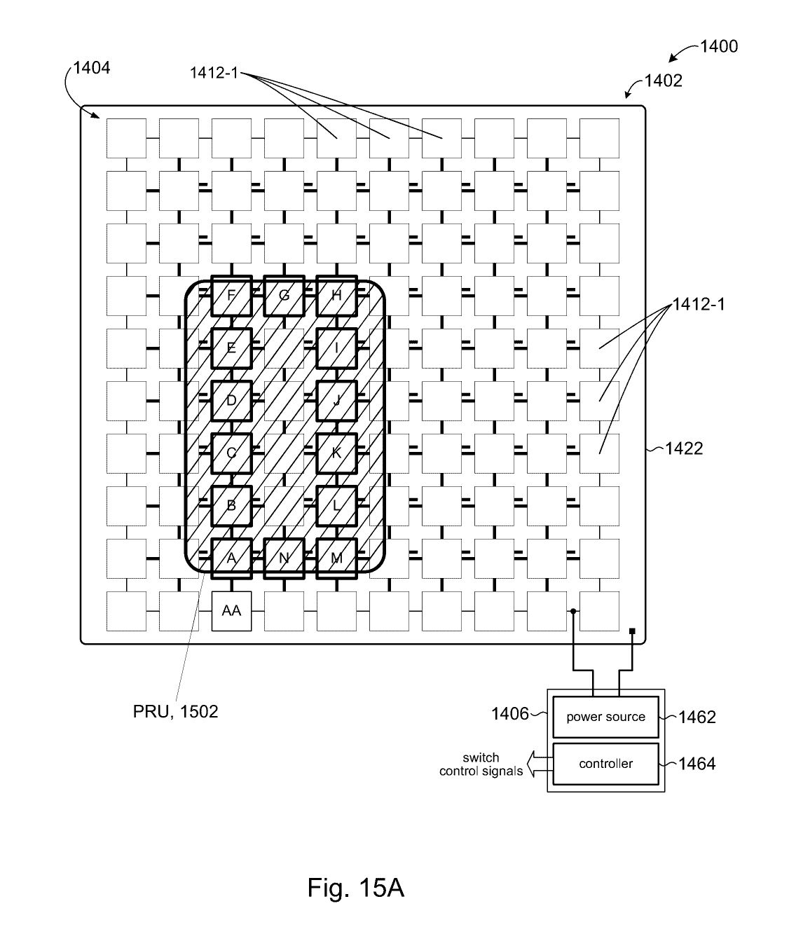

Referring to FIG. 14, in accordance with the present disclosure, a PTU 1400 may comprise a charging platform 1402 and PTU circuitry 1406. The figure depicts the upper (top) side of the charging platform 1402. The PTU circuitry 1406 may include a power source 1462 for driving the charging platform 1402 (e.g., by providing a driving current) and a controller 1464 configured to generate control signals.

The charging platform 1402 may include a charging surface 1404 on which one or more devices (e.g., PRUs) can be placed to for wireless charging. In accordance with the present disclosure, the charging surface 1404 may comprise an arrangement of plates 1412. The plates 1412 may be metal or other electrically conductive material. In some embodiments, the plates 1412 may comprise several different electrically conductive materials. The upper side of the charging surface 1404 may be visible, and so the selection of one or more types of electrically conductive materials for the plates 1412 may motivated for aesthetic reasons to achieve a desired visual design or pattern. In some embodiments, a coating (not shown) may be provided on the plates 1412, for example, to avoid oxidation of an exposed metallic surface. Since the plates 1412 may expose moderate voltages, the coating may be an electrically insulative material. The coating may be transparent to reveal the underlying surface (e.g., for aesthetic reasons), or the coating may be translucent or opaque.

In some embodiments, the charging surface 1404 may be planar, such as depicted in FIG. 14 for example. In other embodiments, the charging surface 1404 may be a contoured, 3-dimensional surface.

The separation of the plates 1412 define a series of slots 1414. The plates 1412 may be supported on a frame or other means for arranging the plates 1412 to define the charging surface 1404. In some embodiments, for example, the slots 1414 may be defined by affixing the plates 1412 on a substrate (not shown) in an arrangement that leaves spacing between the plates 1412. In other embodiments, the slots 1414 may be filled with an electrically non-conductive material in order to hold the plates 1412 together.

FIG. 14A shows an magnified view of the circled region shown in FIG. 14. In accordance with embodiments of the present disclosure, the plates 1412 may be connected by first routing switches 1432. The routing switches 1432 may be provided between pairs of plates 1412, and may selectively electrically connect together and disconnect pairs of plates 1412. For example, FIG. 14A shows that the pair of plates 1412a and 1412b are connected together by a routing switch 1432. Likewise, plates 1412b and 1412d are connected together by a routing switch 1432, plates 1412c and 1412d are connected together by a routing switch 1432, and plates 1412a and 1412c are connected together by a routing switch 1432.

Some of the plates 1412 may further include second “exit” switches 1434. In some embodiments, the exit switches 1434 may selectively connect/disconnect their corresponding plate (e.g., 1412a) to/from an electrically conductive return plane 1422, such as a metal layer for example, that is electrically separated from the plates 1412. As will be explained below, the exit switches provide an exit path for current flowing in the plates 1412. In other embodiments, conductors (not shown) may be used instead of the return plane 1422 to provide an exit path for current flow.

Returning to FIG. 14, some of the plates 1412-1 may be connected together conductors 1436 that are not switched. In some embodiments, for example, plates 1412-1 at the outer periphery of the charging surface 1404 may be connected together to form a conductive ring that encircles the charging surface 1404. In other embodiments, the plates 1412-1 may be configured as two or more electrically separate conductive segments of plates 1412-1.

A first terminal and second terminal may connect the power source 1462, respectively, to one of the conductors 1436 and the return plane 1422. In some embodiments, there may be a single power source 1462 as shown in FIG. 14 to drive a single conductive ring of plates 1412-1. In other embodiments, there may be two or more power supplies to drive two or more conductive segments of plates 1412-1.

The controller 1464 may generate control signals to selectively and separately operate each of the switches 1432, 1434. For example, a routing switch 1432 may have a CLOSED state that electrically connects together a pair of plates (e.g., 1412a, 1412b) and an OPEN state that electrically disconnects the pair of plates 1412a, 1412b. Similarly, an exit switch 1434 may have a CLOSED state that electrically connects a plates (e.g., 1412a) to the return plane 1422 and an OPEN state that electrically disconnects the plates 1412a from the return plane 1422.

In operation, the controller 1464 may assert and de-assert control signals to CLOSE some switches 1432, 1434 and OPEN some switches 1432, 1434 to configure the plates 1412 to form one or more power transmitting elements. A current may be provided to the plates 1412 that comprise the power transmitting elements to generate magnetic fields which emanate from the slots 1414 between the plates 1412 to wirelessly transmit/couple energy to a PRU.

The controller 1464 may operate the switches 1432, 1434 to obtain a suitable configuration of plates 1412 for a given arrangement of power receiving units (PRUs). For example, the controller 1464 may decide what loop(s) to create based on the sensed locations of the PRUs, the desired coupling with the PRUs, and the estimated magnetic field limitation. In some embodiments, the controller 1464 may reconfigure the loops, for example, if the PRUs require a change in magnetic fields. Suppose, for example, two PRUs are present on the charging platform 1402 and one is receiving an insufficient voltage. That PRU may communicate that fact to the controller 1464, and in response, the controller 1464 can reconfigure the plates 1412 to add an extra turn around that PRU to increase the magnetic field and hence increase the amount of power transmitted to that PRU.

The controller 1464 may take into consideration some of the following when configuring or reconfiguring the plates 1412:
H-field. The number of loops, in combination with current from the power source 1462, should be sufficient to create an H-field (magnetic field) sufficient to charge the device. If more than one device is present, then one or more loops can be created to maintain an H-field that is sufficient to charge all devices.
Capacitive losses. Placing one turn of an inductor very close to another turn will tend to increase capacitive losses and AC resistance. The controller 1464 may elect to increase the separation between turns by re-routing a turn.
AC resistive losses. AC resistive losses are proportional to the length of the route, so the controller 1464 may elect to minimize the length of the route to minimize AC losses.
Interference. H-fields (and their associated E-fields) may cause interference to devices or parts of devices. The controller 1464 may elect to change the routing of a loop to avoid sensitive devices, or sensitive areas on devices.
Total H-field minimization. The controller 1464 may elect to make the routed loops as small as possible to decrease the emission of unwanted H-field.
Amplifier impedance. By changing route inductance and length, the impedance presented to the amplifier in the power source 1462 can be adjusted for best efficiency.
Safety. By changing impedance of a coil defined by a configuration of plates 1412, the voltage needed to generate a given current can be reduced. Smaller, parallel-connected resonators may generate lower voltages (an issue if resonator is exposed.)

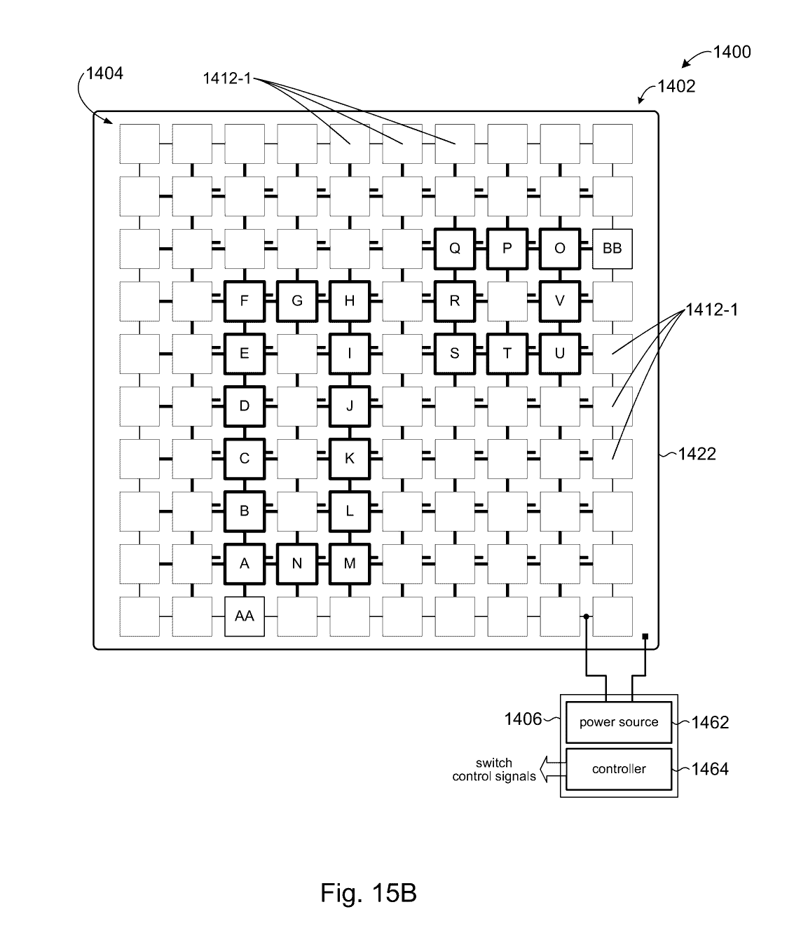

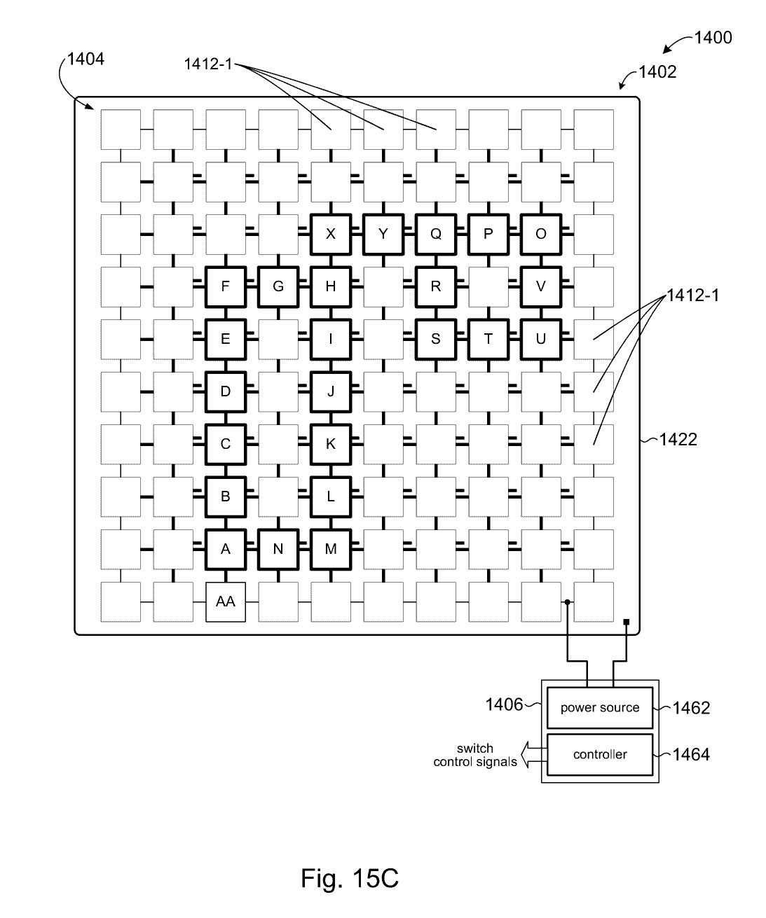

The discussion will now turn to some illustrative examples of configurations of charging surface 1404. FIG. 15A shows a configuration of plates A-N configured as a power transmitting element to wirelessly transmit/couple energy to a PRU 1502. Control signals from the controller 1464 may operate routing switches (e.g., 1432, FIG. 14) between pairs of plates A-N to electrically connect together the plates to form a power transmitting element. For example, the controller 1464 may assert a control signal to operate the routing switch between plate A and plate B to the CLOSED state to electrically connect together plate A and plate B; similarly for plate B and plate C, plate C and plate D, and on to plate M and plate N. The routing switch between plate N and plate A is operated in the OPEN state to electrically disconnect plate A and plate N.

The routing switch between plate A and plate AA may be CLOSED in order to tap power from the power feed defined by the outer periphery plates 1412-1, allowing current from the power source 1462 to flow through plates A to N. The exit switches (e.g., 1434, FIG. 14) may be OPEN for plates A-M. The exit switch for plate N may be CLOSED in order to electrically connect plate N to return plane 1422 to provide a return path to the power source 1462 for the current. Plates A-N shown in FIG. 15A define a coil of one turn, where current from the power source 1462 may enter plate AA, flow though plates A-N, and exit plate N via the return plane 1422. It can be appreciated that coils of two or more turns can be configured by operating the appropriate routing switches to electrically connect together additional plates.

In some embodiments, the routing switches and exit switches of the unused plates may be OPEN; in other words, the unused plates may “float.” This can help to reduce parasitic capacitance. In other embodiments, some or all of the unused plates may be electrically connected together using the routing switches to reduce stray electric and magnetic fields, and in some case may be further be connected to the return plane 1422 using one or more exit switches. A tradeoff may be reduced efficiency due to capacitive cross connections.

FIG. 15B illustrates another configuration example, depicting a second configuration comprising plates O-V; e.g., for wireless power transfer to another PRU (not shown). A one-turn coil is defined by electrically connecting plates O-W. Plate O is connected to plate BB to tap power from the power feed defined by the outer periphery plates 1412-1, and plate V is electrically separate from plate O, but electrically connected via its exit switch to return plane 1422 to provide a return path for the current. FIG. 15B illustrates an example in which the coil A-N and coil O-V are fed in parallel.

FIG. 15C illustrates an example in which coils A-N and O-V are fed in series. Here, two additional plates X and Y may be connected so that current from coil A-N can be tapped (e.g., at plate H) to feed coil O-V (e.g., at plate Q). In this configuration, plate R is electrically disconnected from plate Q, but electrically connected via its exit switch to return plane 1422 to provide a return path for the current. Still other configurations are possible. FIGS. 15A-15C illustrate the flexibility and reconfigurability of the charging platform 1402 in accordance with the present disclosure.

As an example, the PTU 1400 may communicate with PRU 1502 to iteratively configure a coil (e.g., defined by plates A-N). The PTU 1400 may configure the coil dynamically and detect whether or not the configuration is a good one. In some embodiments, for example, the controller 1464 in the PTU 1400 may create a default coil having a default shape and size. The PRU 1502 may periodically communicate information to the PTU 1400 that indicates the level or quality of received voltage or power. The PTU 1400 may adjust the coil in response. For example, the controller 1464 may expand the coil in one direction (e.g., selected randomly), add a turn, etc. When the PTU 1400 receives another communication from the PRU 1502, the PTU 1400 may re-adjust the coil depending on the level or quality of the voltage or power being received at the PRU 1502. This may be repeated until the PRU 1502 receives some predefined level of voltage or power.

The PTU 1400 may be able to detect the presence of a PRU 1502. For example, the PTU 1400 may be configured to detect impedance in a coil (e.g., as defined by plates A-N). The PTU 1400 may be configured to compute how much the impedance would change for a given change in the coil. If the PTU 1400 changes the coil, but does not see an expected corresponding change in impedance, it can be assumed that the PRU 1502 is positioned above the changed portion of the coil. The PTU 1400 may configure a new coil at the changed portion and repeat the process to identify the location and orientation of the PRU 1502.

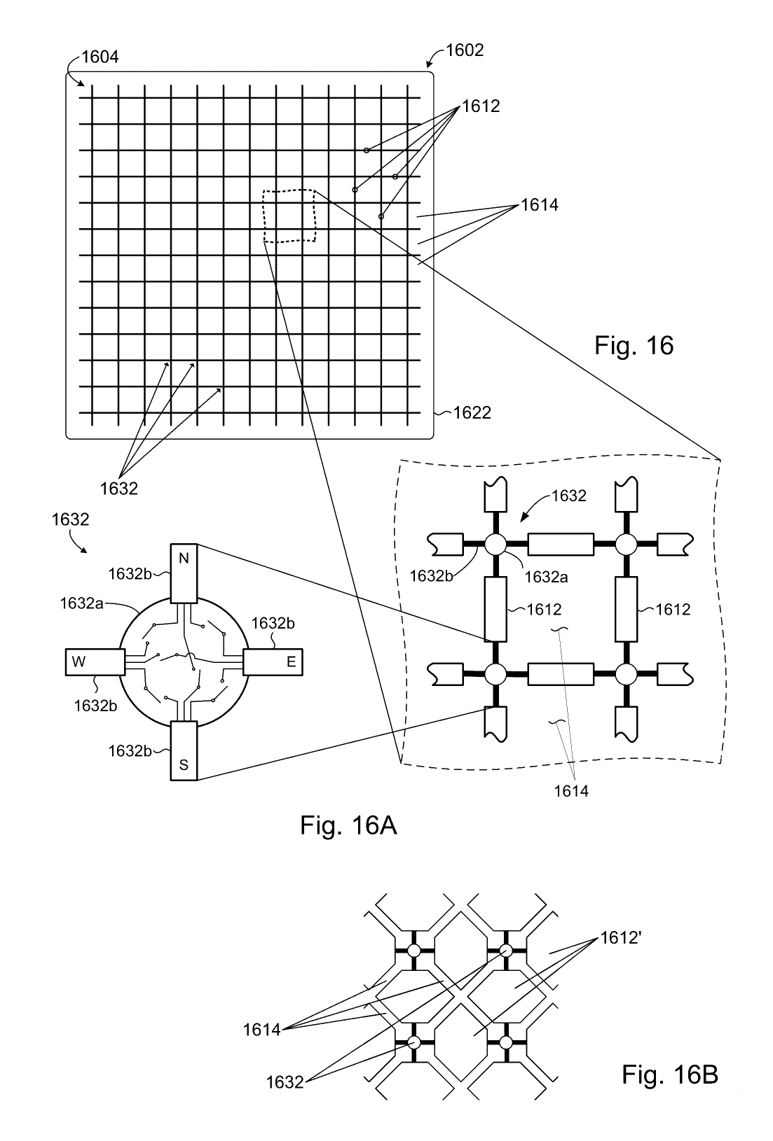

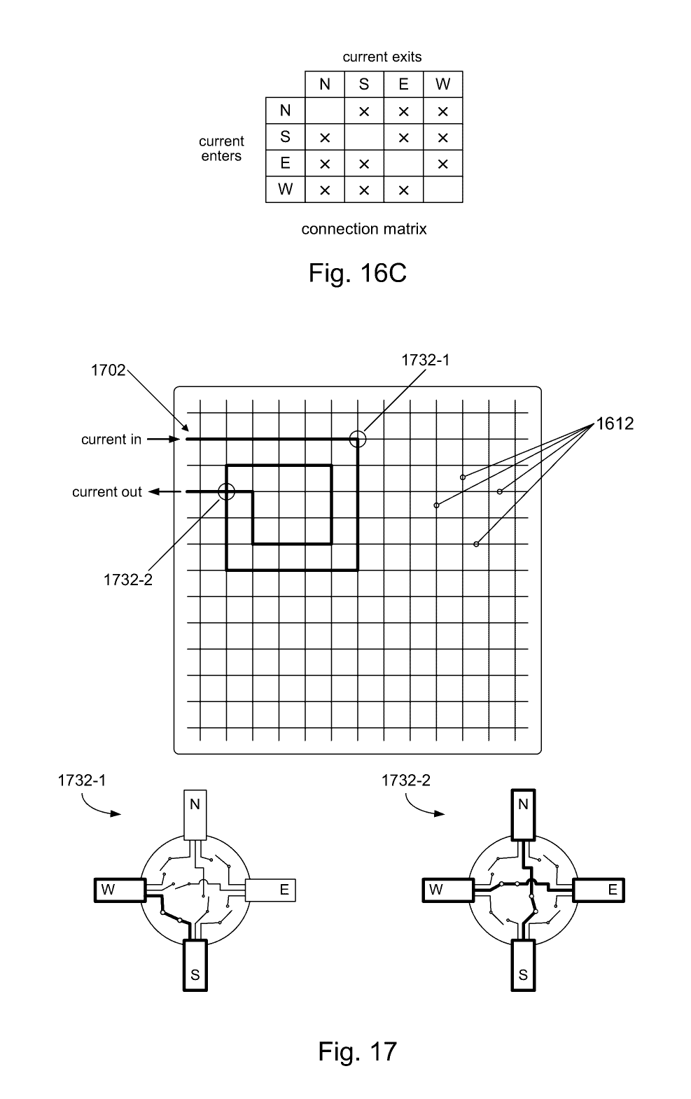

FIG. 16 shows a charging platform 1602 in accordance with some embodiments of the present disclosure. The charging platform 1602 may comprise a charging surface 1604 defined by an arrangement of electrically conductive plates 1612. The plates 1612 may be spaced apart to define slots 1614. The plates 1612 may be supported on a frame 1622 or other means for arranging the plates 1612 to define the charging surface 1604, and interconnected by crosspoint switches 1632.

FIG. 16A shows details of a portion of charging surface 1604 depicted in FIG. 16. In some embodiments, the plates 1612 may have different dimensions than previously disclosed. FIG. 16A, for example, shows the plates 1612 have a narrow dimension, allowing for wider slots 1614. Referring for a moment to FIG. 16B, in other embodiments, the plates 1612′ may have a non-rectilinear geometry. It will be appreciated that still other patterns are possible for the electrically conductive plates.

Continuing with FIG. 16A, each crosspoint switch 1632 may connect to four of the plates 1612. Each crosspoint switch 1632 may comprise a switching node 1632a and four terminals 1632b, labeled N, S, E, W (north, south, east, west). Each terminal 1632b may connect to a plate 1612. The switching node 1632a may comprise a collection of switching elements, such as illustrated in FIG. 16A, that can connect together any combination of the terminals N, S, E, W and hence any combination of the four plates 1612 connected to those terminals. Accordingly, current entering a given terminal (e.g., the north terminal) can be directed to exit any one or more of the other terminals S, E, W. The connection matrix shown in FIG. 16C summarizes the possible combinations.

Some considerations in the design of the crosspoint switches 1632 include:
Minimization of on-resistance. The lower the on-resistance the higher the efficiency.
Maximization of off-state isolation. The greater the isolation, the more predictable the characteristics of the resonator.
Reduction of stray off-state capacitance. High off-state capacitances can cause unwanted coupling, making it impossible to completely “turn off” areas—and introducing the potential for unwanted resonances.
Reduction of stray capacitance between crosspoint switches 1632 and control circuitry. Careful design using very high impedances, non-galvanic coupling (optical or wireless) or drive transformers can mitigate this.

FIG. 17 illustrates the additional flexibility provided by crosspoint switches 1632 (FIG. 16). The figure shows a power transmitting element 1702 comprising a configuration of the plates 1612 connected to form a two-turn coil. The horizontal segments of the power transmitting element 1702 may be defined, for example, by connecting the east and west terminals of the crosspoint switches between the plates that comprise the horizontal segments. The vertical segments of the power transmitting element 1702 may be similarly defined by connecting the north and south terminals of the crosspoint switches between the plates that comprise the vertical segments. The 90° turns may be defined by connecting a north/south terminal with an east/west terminal. The crosspoint switch 1732-1, for example, may connect the horizontal plate to the vertical plate by connecting the west terminal with the south terminal, as depicted in FIG. 17.

The crosspoint switches may allow the routing of plates 1612 to cross. FIG. 17, for example, shows a crossing at crosspoint switch 1732-2. As depicted in FIG. 17, the north and south terminals of cross point switch 1732-2 are connected together, and likewise, the east and west terminals of crosspoint switch 1732-12 are connected together. The crosspoint switch allows the horizontal and vertical legs to cross without shorting together current flowing in the respective legs.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. An apparatus for wireless power transmission comprising:
a charging surface comprising a plurality of electrically conductive plates physically spaced apart from each other by a plurality of slots; and
a current driving circuit configured to induce, in one or more of the plurality of electrically conductive plates, eddy currents which cause magnetic fields to emanate from one or more of the plurality of slots and establish a charging area about the charging surface defined by the magnetic fields to wirelessly transfer power to one or more power receiving units via the magnetic fields.

2. The apparatus of claim 1, wherein the current driving circuit comprises at least one coil of conductive material disposed on one or more of the plurality of electrically conductive plates, the at least one coil of conductive material having terminals configured to electrically connect to a power source.

3. The apparatus of claim 2, wherein the current driving circuit further comprises one or more capacitors electrically connected to the at least one coil of conductive material to establish a resonant frequency for the current driving circuit.

4. The apparatus of claim 2, wherein the at least one coil of conductive material is wound about a periphery of the charging surface.

5. The apparatus of claim 1, wherein the current driving circuit comprises at least one coil of conductive material exposed through one or more of the plurality of electrically conductive plates, the at least one coil of conductive material having terminals configured to electrically connect to a power source.

6. The apparatus of claim 1, wherein the current driving circuit comprises a first coil of conductive material disposed across a first set of the plurality of electrically conductive plates; a second coil of conductive material arranged inside a perimeter established by the first coil of conductive material and intersects some of the plurality of slots; and a connector that electrically connects the first coil to the second coil.

7. The apparatus of claim 1, wherein the current driving circuit comprises one or more coils of conductive material disposed at a periphery of the charging surface.

8. The apparatus of claim 1, wherein the current driving circuit is configured to directly induce eddy currents in a subset of the plurality of electrically conductive plates, wherein the eddy currents in others of the plurality of electrically conductive plates are induced by the subset of the plurality of electrically conductive plates.

9. The apparatus of claim 1, wherein the current driving circuit comprises a first conductor that lies along a first side of the charging surface and at least a second conductor that lies along a second side of the charging surface, wherein the charging area is established between the first conductor and the second conductor.

10. The apparatus of claim 9, wherein the first conductor is connected in series with the second conductor.

11. The apparatus of claim 1, further comprising a magnetic shielding material disposed on one or more of the plurality of electrically conductive plates that are inside a perimeter established by the current driving circuit.

12. The apparatus of claim 1, further comprising magnetic shielding material disposed on one or more of the plurality of electrically conductive plates that are outside a perimeter established by the current driving circuit.

13. The apparatus of claim 1, further comprising a signal feed connected to one or more of the plurality of electrically conductive plates, the signal feed configured to provide a first signal for transmission by the one or more of the plurality of electrically conductive plates and to receive a second signal received by the one or more of the plurality of electrically conductive plates.

14. An apparatus for wireless power transmission comprising:
a charging surface configured to produce magnetic fields for wireless transmission of power to one or more power receiving units, the charging surface comprising a plurality of electrically conductive plates physically spaced apart from each other and electrically separable from each other;
a plurality of first switches selectively and separately operable to electrically connect or disconnect pairs of the plurality of electrically conductive plates, the plurality of first switches operable to form a first configuration of connected and disconnected electrically conductive plates including a first set of electrically conductive plates electrically connected together to define a first power transmitting element; and
first and second terminals configured to receive power from a power source and provide the received power to the first power transmitting element to generate magnetic fields which emanate from slots between the first set of electrically conductive plates that comprise the first power transmitting element.

15. The apparatus of claim 14, wherein the plurality of first switches are disposed in the slots between the plurality of electrically conductive plates.

16. The apparatus of claim 14, wherein each first switch is connected between a pair of the plurality of electrically conductive plates, and has an OPEN state that electrically disconnects the pair of the plurality of electrically conductive plates from each other and a CLOSED state that electrically connects the pair of the plurality of electrically conductive plates together.

17. The apparatus of claim 14, wherein each first switch is connected between four of the plurality of electrically conductive plates and is operable to connect together any combination of the four electrically conductive plates.

18. The apparatus of claim 14, further comprising one or more second electrically conductive plates electrically connected to the first terminal, the plurality of first switches operable to connect one or more of the plurality of electrically conductive plates to the one or more second electrically conductive plates.

19. The apparatus of claim 14, further comprising a plurality of second switches selectively and separately operable to electrically connect or disconnect some of the plurality of electrically conductive plates to the second terminal.

20. The apparatus of claim 19, wherein one of the electrically conductive plates of the first power transmitting element is connected to the first terminal by one of the plurality of first switches and another one of the electrically conductive plates of the first power transmitting element is connected to the second terminal by one of the plurality of second switches.

21. The apparatus of claim 14, further comprising a controller configured to operate the plurality of first switches to connect together different electrically conductive plates to form one or more power transmitting elements including the first power transmitting element.

22. The apparatus of claim 14, further comprising a controller configured to operate the plurality of first switches to reconfigure the first configuration of connected and disconnected electrically conductive plates to form a second configuration of connected and disconnected electrically conductive plates in response to information received from one or more power receiving units.

23. The apparatus of claim 14, further comprising a controller configured to operate the plurality of first switches to electrically connect together the first set of the plurality of electrically conductive plates to define the first power transmitting element.

24. A method for wireless power transmission comprising:
producing one or more flows of current among some of a plurality of electrically conductive plates that are arranged to define a charging surface;
producing magnetic fields in response to the one or more flows of current; and
coupling the magnetic fields to a power receiving unit in proximity to the charging surface to wirelessly transmit power to the power receiving unit.

25. The method of claim 24, wherein producing one or more flows of current includes providing current to a coil of conductive material disposed on some of the plurality of electrically conductive plates to induce eddy currents in others of the plurality of electrically conductive plates.

26. The method of claim 24, wherein producing one or more flows of current includes driving one or more source plates from the plurality of electrically conductive plates with a drive current to induce eddy currents in non-source plates proximate the one or more source plates.

27. The method of claim 24, wherein producing one or more flows of current, includes:
operating a plurality of switches, which are configured to electrically connect or disconnect pairs of the plurality of electrically conductive plates, to electrically connect together a first set of the plurality of electrically conductive plates to define a power transmitting element; and
providing power to the power transmitting element to generate magnetic fields that emanate from slots between the first set of the plurality of electrically conductive plates of the power transmitting element.

28. An apparatus for wireless power transmission comprising:
means for producing flows of current among some of a plurality of electrically conductive plates that define a charging surface; and
means for generating magnetic fields that arise due to the flows of current among some of the plurality of electrically conductive plates in order to couple the magnetic fields to a power receiving unit disposed in proximity to the charging surface to wirelessly transmit power to the power receiving unit.

29. The apparatus of claim 28, wherein the means for producing one or more flows of current comprises one or more coils of conductive material disposed on one or more of the plurality of electrically conductive plates to induce current among some of the plurality of electrically conductive plates.

30. The apparatus of claim 28, wherein the means for producing one or more flows of current comprises a plurality of switches configured to electrically connect or disconnect pairs of the plurality of electrically conductive plates.
